(19) United States
(12) Patent Application Publication
(10) Pub. No.: US 2025/0391986 A1
(43) Pub. Date: Dec. 25, 2025

(54) BATTERY ASSEMBLY

(71) Applicant: Streamlight, Inc., Eagleville, PA (US)

(72) Inventors: Joshua Hawk, Limerick, PA (US); Thomas D. Boris, Collegeville, PA (US)

(21) Appl. No.: 19/243,104

(22) Filed: Jun. 19, 2025

Related U.S. Application Data
(63) Continuation-in-part of application No. 19/191,863, filed on Apr. 28, 2025.
(60) Provisional application No. 63/662,503, filed on Jun. 21, 2024.
(60) Provisional application No. 63/709,764, filed on Oct. 21, 2024.

(51) Int. Cl. H01M 50/291; F21L 4/00; H01M 50/213; H01M 50/247; H01M 50/262; H01M 50/271; H01M 50/514; H01M 50/519

(52) U.S. Cl. CPC H01M 50/291; F21L 4/005; H01M 50/213; H01M 50/247; H01M 50/262; H01M 50/271; H01M 50/514; H01M 50/519; H01M 2220/30

(57) ABSTRACT

A battery assembly for a portable device has a first longitudinal axis and comprises: a battery assembly housing configured to receive at least one unit of a first battery type having a second longitudinal axis, wherein an angle A1 defined by the first and second longitudinal axes is greater than 0 degrees and less than 180 degrees. The battery assembly housing may be further configured to receive at least one unit of a second battery type. The battery assembly for a portable device may comprise: a housing having a first receptacle for receiving a first battery and having plural second receptacles transverse to the first receptacle for receiving plural batteries of a different smaller size. Battery assembly terminals provide externally accessible battery positive and negative terminals. Thus the battery assembly can receive the first and second batteries, but not at the same time.

This Application claims the priority of and the benefit of U.S. patent application Ser. No. 19/191,863 filed Apr. 28, 2025, entitled “LIGHTING DEVICE,” of U.S. Patent Application 63/709, 764 filed Oct. 21, 2024, entitled “LIGHTING DEVICE,” and of U.S. Patent Application 63/662,503 filed Jun. 21, 2024, entitled “BATTERY ASSEMBLY,” each of which is hereby incorporated herein by reference in its entirety for any and all purposes. U.S. patent application Ser. No. 29/969,158 filed Oct. 21, 2024, entitled “LIGHTING DEVICE,” is hereby incorporated herein by reference in its entirety for any and all purposes.

The present invention relates to a battery assembly and, in particular, to a battery assembly configured to receive batteries of different sizes.

Batteries of many different physical sizes, e.g., AA, AAA, CR123, B26, B50 and the like, are, generally speaking, commercially available, as are batteries of many different internal chemistries, e.g., alkaline cells, NiMH, lead-acid, various lithium (Li) formulations, and the like. Certain battery operated devices, e.g., including portable lights, flashlights and the like, are configured to receive particular sizes and kinds of batteries that the manufacturer deems appropriate in view of the physical size of the device, the desired operating time from a battery (e.g., often referred to as “run time” of the electronic device), the desired light or other output, and the intended uses and environments in which such devices are expected to be used.

However, not all battery sizes and types are always readily available to a user. This can occur when a replacement battery is needed while out in the field where the selection of available replacement batteries is often limited, even assuming that the user has planned well, or when a store, even a so-called large “big-box” retail store, has a limited selection of batteries and battery types, or when particular batteries are out of stock.

To ease the need for a specific type and size of a replacement battery, manufacturers have created devices that can accept batteries of different sizes and/or chemistries. A fine example of such innovative device is the SIDEWINDER COMPACT® II hands free light available from Streamlight, Inc. of Eagleville Pennsylvania, which can be operated using an AA alkaline battery, an AA lithium battery or a CR123A lithium battery. Such lights and devices are sometimes referred to as “dual-fuel” because they can be powered by, e.g., “fueled” by, batteries of two or more different sizes and/or kinds.

Not all devices are or can be configured in that manner due to the size and/or shape of the device, or due to the desire for a new light to be physically compatible with auxiliary equipment such as charging or storage racks, or for a new battery to be physically compatible with an existing device or a family of existing devices. This can be particularly challenging where a large number of devices are employed and more so when plural users may be using the same devices interchangeably. Firefighters, for example, use powerful portable lights in their work and such lights are typically stored in racks, or in charging racks, on their vehicles or other equipment or a station facility, where replacement of the racks can be inconvenient, expensive and time consuming. Such lights often utilize replaceable battery packs, more formally battery assemblies, which can easily be carried and quickly replaced when necessary. Such battery assemblies may include, e.g., single use batteries or rechargeable batteries, and because of the demands of the application of the lights, are often of a custom size and shape.

Many commercial batteries are cylindrical or rectangular in shape and have an end cap that provides one or more electrical contacts as well as a seal for scaling a cylindrical or rectangular battery housing or case that contains the battery plates (electrodes), separators, electrolytes and the like. A common failure mode of such batteries is a failure of the seal which can allow chemicals from inside the battery to leak and contaminate, and often corrode or otherwise degrade, parts of the device that contains the battery. In addition to design choices and/or manufacturing defects that may lead to a seal failure, physical impact or loading may also lead to seal failure.

Applicant believes there may be a need for a battery assembly that can receive batteries of different sizes and/or shapes and/or different battery chemistries, and that may in some applications, where desired, be configured to be interchangeable with previously available conventional battery packs. It would also be desirable to have a battery assembly that may improve resistance to physical damage to the battery or batteries therein.

Accordingly, a battery assembly for a portable device has a first longitudinal axis and comprises: a battery assembly housing configured to receive at least one unit of a first battery type having a second longitudinal axis, wherein an angle A1 defined by the first and second longitudinal axes is greater than 0 degrees and less than 180 degrees. The battery assembly housing may be further configured to receive at least one unit of a second battery type.

According to another aspect, a battery assembly may comprise: a battery assembly housing having first and second housing parts each having a respective receiving surface that is configured to be placed adjacent to the receiving surface of the other housing part, the receiving surface of the first housing part having at least a first receptacle for receiving a battery of a first size and having two or more second receptacles for receiving two or more batteries of a second size, wherein the size of the battery of the first size is larger than the size of the batteries of the second size and wherein the two or more second receptacles are transverse to the first receptacle; the receiving surface of the second housing part having a first receptacle complementary to the first receptacle of the first housing part and having two or more second receptacles complementary to the two or more second receptacles of the first housing part; first and second battery assembly terminals supported by the battery assembly housing and accessible from exterior to the battery assembly; first and second battery contacts in each of the first and second receptacles configured to make electrical connection to terminals of the respective battery disposed therein; plural electrical conductors disposed within the battery assembly housing configured to electrically connect the first and second battery contacts in circuit with the first and second battery assembly terminals, respectively; and one or more fasteners retain the first and second housing parts with their respective receiving surfaces adjacent each other. Thus the first receptacles of the first and second housing parts are retained adjacent each other and the second receptacles of the first and second housing parts are retained adjacent each other to define respective first and second cavities that are transverse to one another for receiving batteries of the first and second sizes, respectively, but not at the same time.

In a further aspect, a battery assembly for a portable device may comprise: a first housing part having at least a first receptacle for receiving a battery of a first size and having two or more second receptacles for receiving two or more batteries of a second size, wherein the size of the battery of the first size is larger than the size of the batteries of the second size and wherein the two or more second receptacles are configured to be transverse to the first receptacle, whereby the first housing part can not receive the battery of the first size and the two or more batteries of the second size at the same time; first and second battery assembly terminals supported by the first housing part and accessible from exterior to the battery assembly to provide an externally accessible battery positive terminal and an externally accessible battery negative terminal; plural electrical conductors disposed with the first housing part and configured to electrically connect terminals of the battery of the first size and terminals of the batteries of the second size in circuit with the first and second battery assembly terminals, respectively. Thus the battery assembly defines respective first and second cavities that are transverse to one another for receiving batteries of the first and second sizes, respectively, but not at the same time.

In summarizing the arrangements described and/or claimed herein, a selection of concepts and/or elements and/or steps that are described in the detailed description herein may be made or simplified. Any summary is not intended to identify key features, elements and/or steps, or essential features, elements and/or steps, relating to the claimed subject matter, and so are not intended to be limiting and should not be construed to be limiting of or defining of the scope and breadth of the claimed subject matter.

### BRIEF DESCRIPTION OF THE DRAWING

The detailed description of the preferred embodiment(s) will be more easily and better understood when read in conjunction with the FIGURES of the Drawing which include:

FIG. 1 is a perspective view of a prior art battery powered light and its battery pack, with an example embodiment of a compatible replacement battery assembly of the sort described herein;

FIGS. 2A-2B include orthogonal views of an example embodiment of a battery assembly for a portable battery powered device;

FIGS. 3A and 3B are perspective views of the example battery assembly with a cover thereof removed and with different first and second example batteries disposed therein;

FIGS. 4A and 4B are plan views of the example battery assembly with a cover thereof removed and with different first and second example batteries disposed therein;

FIG. 4C includes views of an example battery in different angular positions, e.g., at angles A, and FIG. 4D is a graphical representation of an effective length thereof;

FIGS. 5A and 5B are exploded views of the example battery assembly including one set of example batteries therefor; and

FIG. 6 is a plan view of an example housing cover part of the example battery assembly.

In the Drawing, where an element or feature is shown in more than one drawing figure, the same alphanumeric designation may be used to designate such element or feature in each figure, and where a closely related or modified element is shown in a figure, the same alphanumerical designation may be primed or designated “a” or “b” or the like to designate the modified element or feature. Similar elements or features may be designated by like alphanumeric designations in different figures of the Drawing and with similar nomenclature in the specification. As is common, the various features of the drawing are not to scale, the dimensions of the various features may be arbitrarily expanded or reduced for clarity, and any value stated in any Figure is by way of example only.

### DESCRIPTION OF THE PREFERRED EMBODIMENT(S)

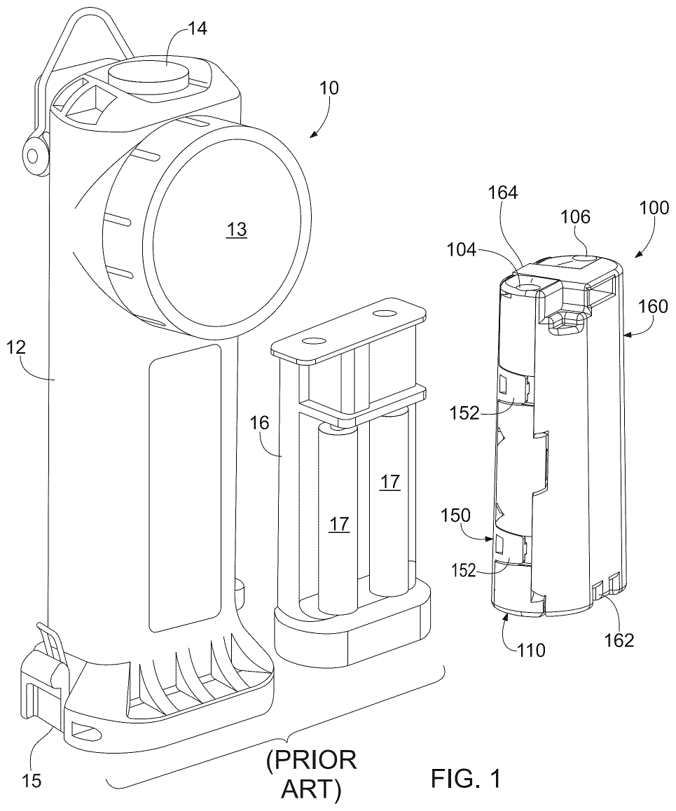

FIG. 1 is a perspective view of a prior art battery powered light 10 and its battery pack 16, with an example embodiment of a compatible replacement battery assembly 100 of the sort described herein also illustrated therein. Prior art light 10 has a housing 12, and a light source 13 and an actuator 14 on the housing 12. Actuator 14 controls operation of the light source 13, e.g., ON/OFF, brightness, and the like. A cover 15 at the bottom of housing 12 is openable for inserting and removing a conventional (prior art) battery pack 16 which, as illustrated receives two batteries 17 of the same size, and battery pack 16 can not accept, e.g., different batteries of different sizes. Batteries 17 provide electrical power to light 10 via, e.g., terminals on the top side of battery pack 16 which make connection to complementary battery contacts interior to housing 12 of light 10.

If prior art light 10 and its battery pack 16 are configured for employing rechargeable batteries 17, contacts on cover 15 may provide connections to an external charging device (not shown) from, e.g., charging terminals on the bottom of battery pack 16 when battery pack 16 is disposed in light 10. Typically, portable light 10 is charged by being inserted in an external charging device (not shown) with battery pack 16 inside portable light 10; however, a battery pack 16 may be removed from light 10 and be charged on an external charging device, which can be the same charging device that receives portable light 10 for charging.

Example battery assembly 100 in accordance with the present disclosure comprises a main housing part 110 and a complementary main housing cover part 160 that when placed adjacent each other form a housing for battery assembly 100 that defines plural receptacles or recesses therein for receiving batteries of different types, sizes and kinds, as described below.

In certain embodiments and applications, a battery assembly in the arrangement of battery assembly 100 may not only be physically compatible in size and shape with a predecessor conventional battery pack, but may also be arranged to receive batteries or other power sources therein that could not fit in a conventional battery pack of like size and shape and/or that provide greater electrical power than the batteries or other power sources that such conventional battery pack of like size and shape can receive.

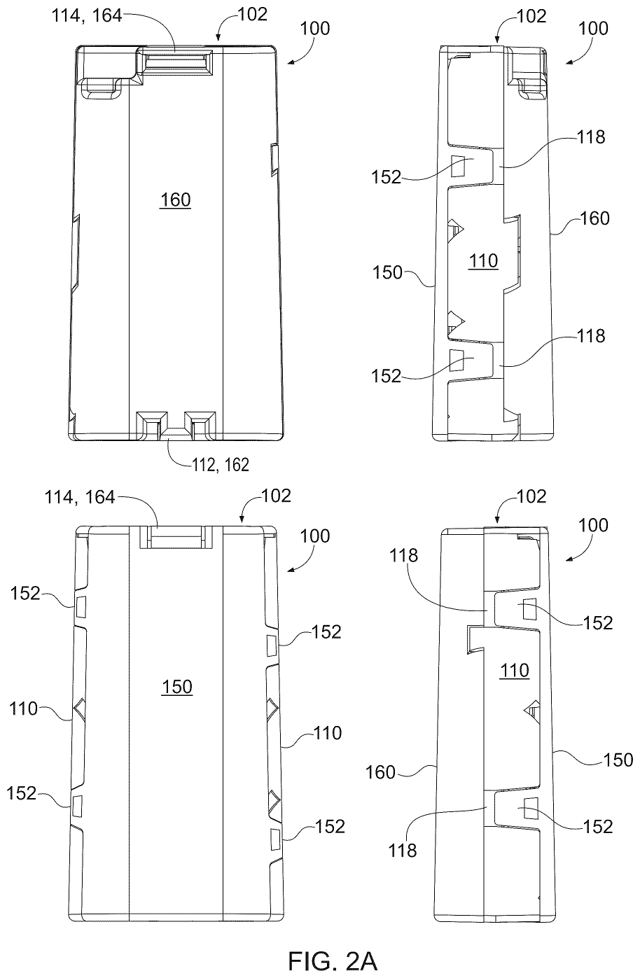

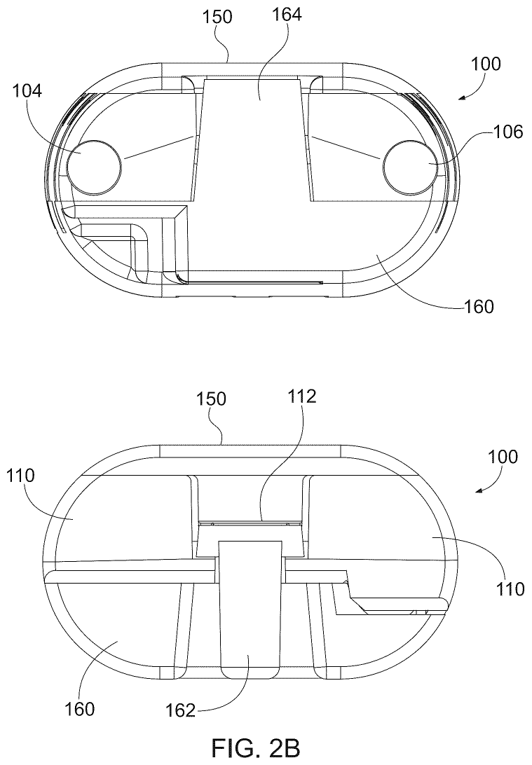

FIGS. 2A-2B include orthogonal views of an example embodiment of a battery assembly 100 for a portable battery powered device, such as for a portable light 10 or similar or different lights, that is/are configured to receive a battery assembly such as or similar to battery assembly 100. Example battery assembly 100 includes a main housing receptacle or part 110 that is configured internally to receive two or more different batteries that can be of different sizes, types and kinds and a main housing cover 160 that is of similar size and shape to that of main housing part 110 at their interface; i.e. at their respective faces which are adjacent one to the other in an assembled battery assembly 100. Main housing part 110 and main housing cover 160 together define a main housing for battery assembly 100.

Main housing cover 160 has an internal configuration that is complementary to that of main housing part 110 so that when housing parts 110 and 160 are disposed adjacent to each other, their complementary internal configurations cooperate to define plural receptacles for receiving therein the two or more different batteries that can be of different sizes, types and kinds. By way of example, when the sources of electrical power that are to be disposed in battery assembly 100 are of substantially cylindrical shape, each of main housing part 110 and main housing cover 160 have respective substantially semi-cylindrical recesses or receptacles that are adjacent to each other and complementary so as to together define substantially cylindrical cavities in which the cylindrical sources of electrical power can be disposed.

Main housing part 110 and main housing cover 160 may be separated one from the other and may be fastened together, e.g., to retain a battery B1 or batteries B2 to be retained in their receptacles 120 or 130, respectively, therein. In an example arrangement, fasteners 112, 162 and 114, 164 may include hinges and/or latches. In the illustrated example, fastener 112, 162 is a hinge having a first hinge element 112, e.g., a T-shaped projection, that engages a second hinge element 162, e.g., a T-shaped recess 162, wherein main housing parts 110 and 160 are hinged with respect to each other, whereby they can be moved to become adjacent to each other (i.e. closed to contain battery B1 or B2) or separated from each other (i.e. opened to provide access to battery B1 or B2). Fastener 112, 162 can be configured so that they remain engaged to maintain housing parts 110, 160 connected to each other, or so that they can be disengaged to allow housing parts 110, 160 to be separated from each other.

Also in the illustrated example, fastener 114, 164 is a latch having a first latch element 114, e.g., a raised rib-like projection, that engages a second latch element 164, e.g., a somewhat flexible projection 164, wherein main housing parts 110 and 160 are latched with respect to each other, whereby main housing parts 110, 160 are retained adjacent to each other (i.e. closed to contain battery B1 or B2) by latch 114, 164, or can be separated from each other (i.e. opened to provide access to battery B1 or B2) when flexible latch element 164 is flexed to disengage from latch projection 114 to enable main housing parts 110, 160 to be moved apart from each other, and by disengaging latch hinge elements 112, 162, be separated from each other.

The material with which housing parts 110, 160 are made, e.g., typically a plastic material, has sufficient flexibility to allow latch element 164 to be flexed outwardly to disengage from latch element 114 for opening battery assembly 100, e.g., moving housing parts 110, 160 away from each other, while also having sufficient rigidity to bear against latch element 114 to maintain battery assembly 100 in a closed configuration with housing parts 110, 160 adjacent to each other for retaining batteries B1 or B2 therein.

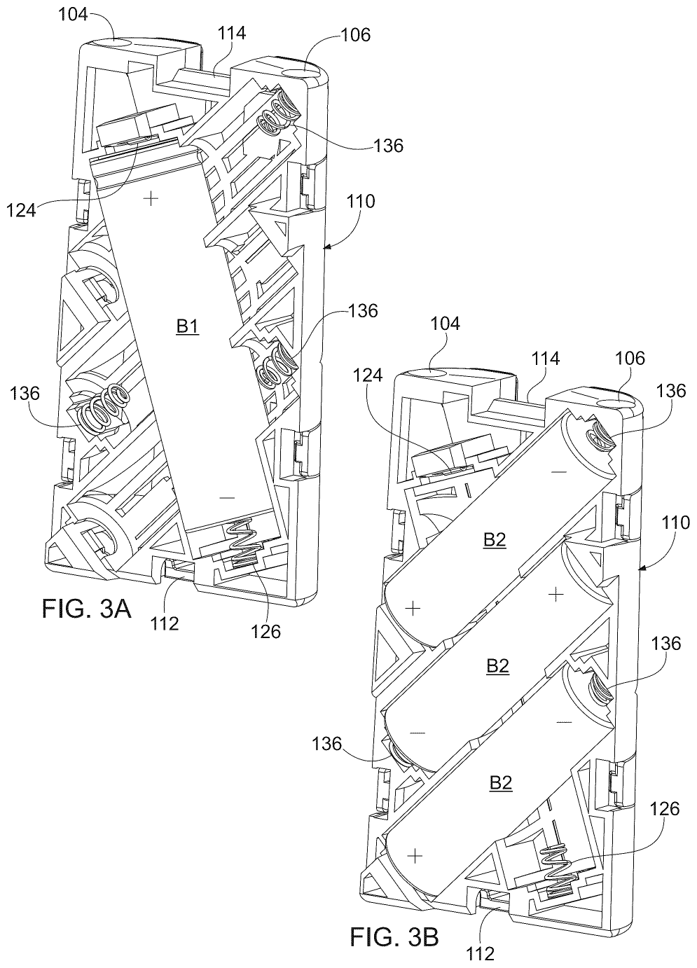

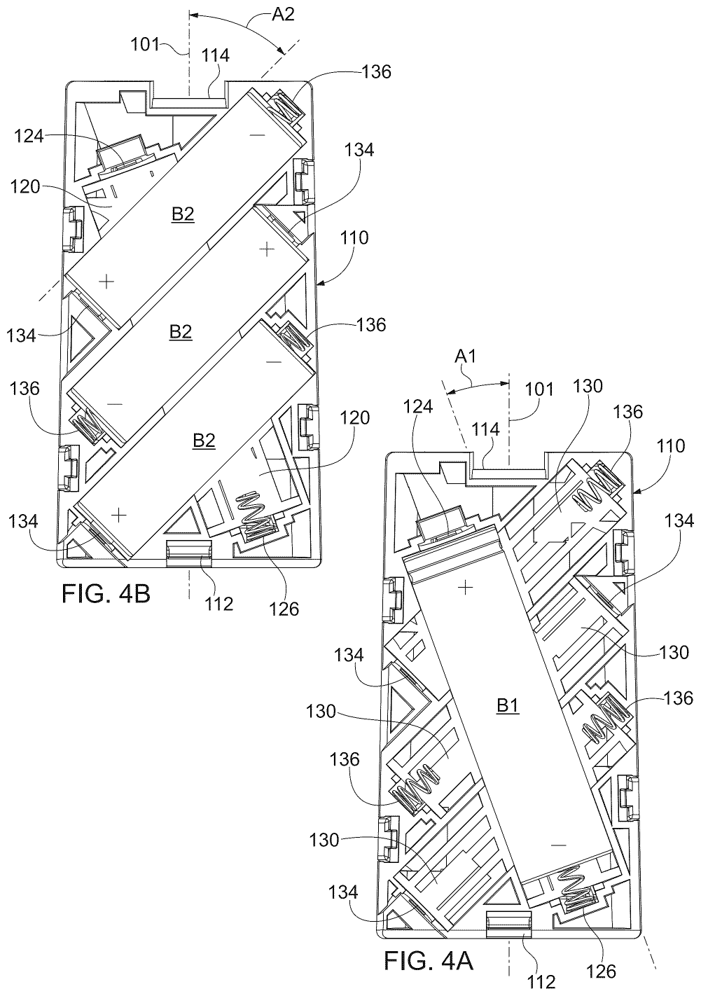

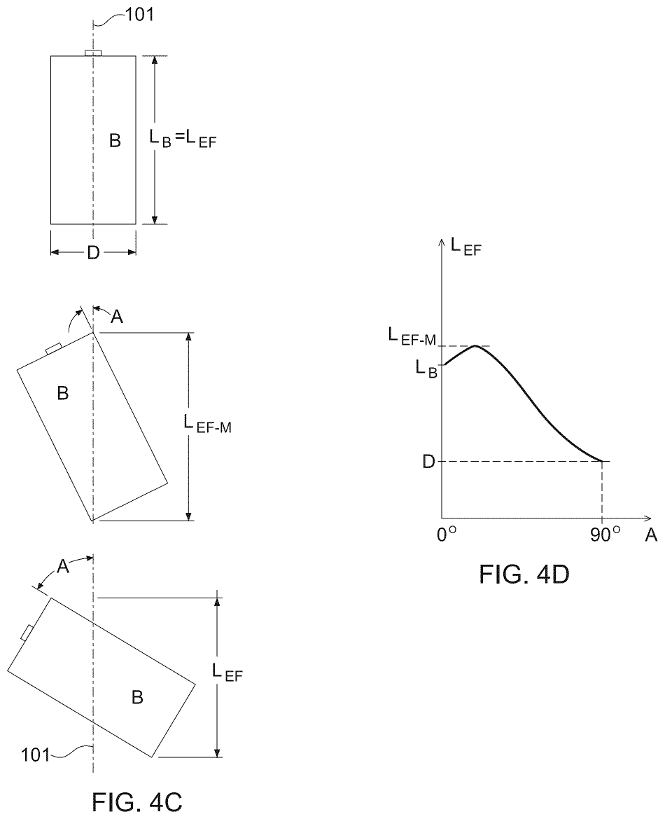

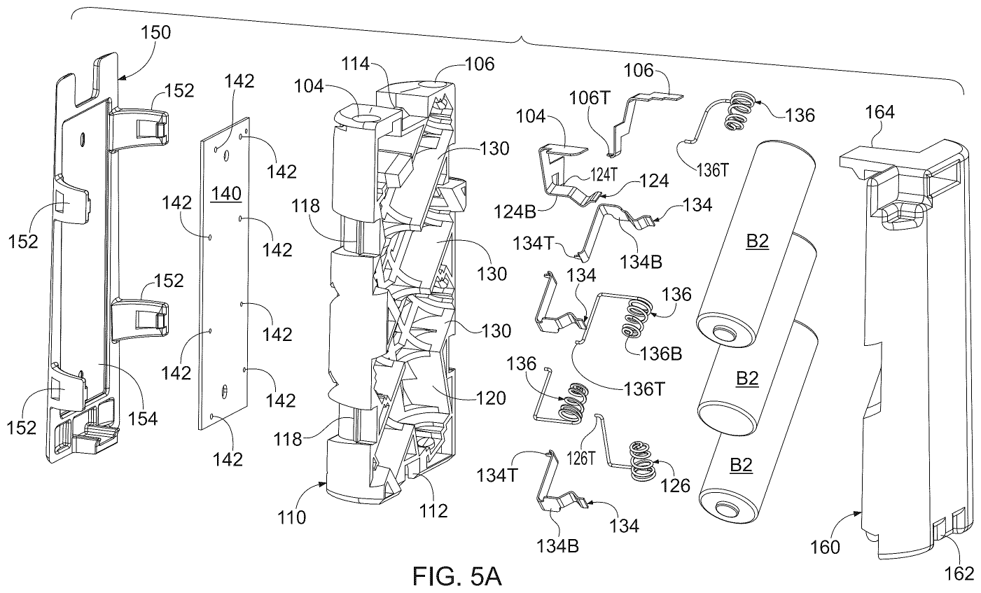

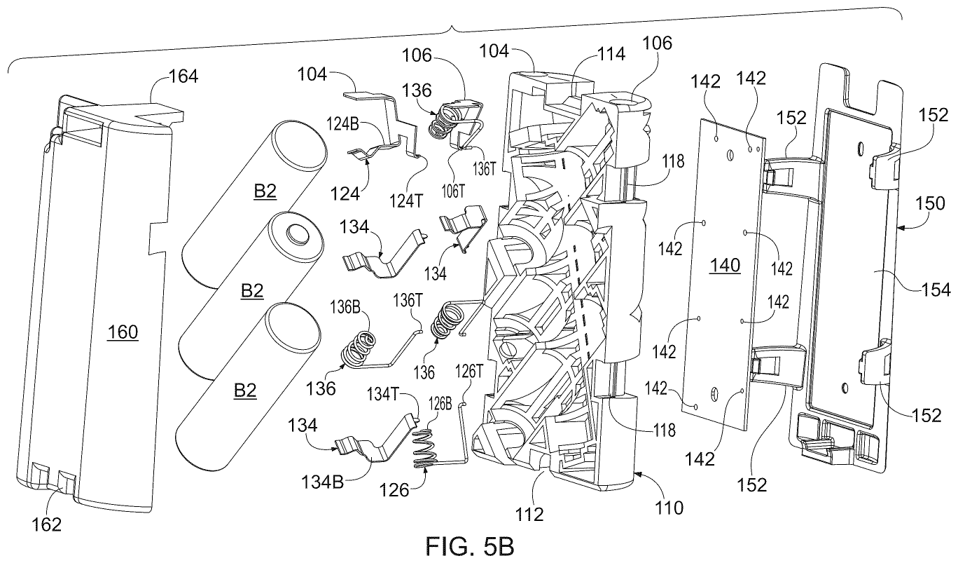

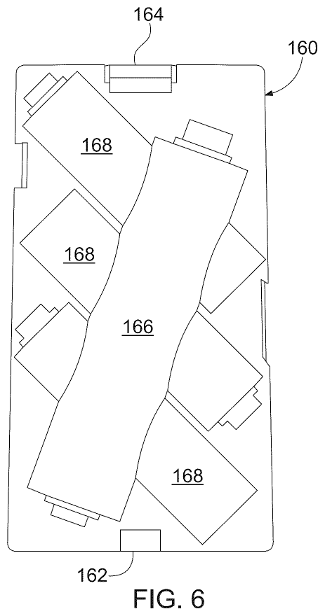

FIGS. 3A and 3B are perspective views of the example battery assembly 100 with a cover 160 thereof removed and with different first and second example batteries B1 or B2, respectively, disposed therein; FIGS. 4A and 4B are plan views of the example battery assembly 100 with a cover 160 thereof removed and with different first and second example batteries B1, B2 disposed therein; and FIGS. 5A and 5B are exploded views of the example battery assembly 100 including one set of example batteries B2 therefor; and FIG. 6 is a plan view of an example housing cover part 160 of the example battery assembly 100.

Complementary housing parts 110, 160, e.g., main housing part 110 and main housing cover part 160, are configured to be disposed adjacent to each other for retaining batteries B1 or B2 disposed in recesses 120 or 130 therein in battery assembly 100. For purposes of this description, battery assembly 100 is deemed to define a longitudinal direction or axis between the opposing ends thereof, e.g., the ends shown in FIG. 2B, typically the longer direction thereof. Further, while the illustrated example embodiment provides receptacles for one battery B1 of a larger size and three receptacles for three batteries of a smaller size, a battery assembly 100 may be configured to have receptacles for one or more batteries B1 of the larger size and/or for one or more batteries B2 of the smaller size, as may be desired in any particular instance.

The surface of main housing part 110 that is interior to battery assembly 100 defines respective cavities 120 and 130 for two different sources of electrical power, e.g., for one or more physically larger batteries B1 and for one or more physically smaller batteries B2. The illustrated example battery assembly 100 includes a larger battery cavity 120 configured to receive a physically larger battery B1 and includes plural battery cavities 130 configured to receive plural physically smaller batteries B2, which typically are connected in series. Separate contacts are provided to physically and electrically connect to terminals at each end of each battery B1, B2.

Each battery cavity 120, 130 has a pair of electrical contacts configured to make electrical connection to the terminals of batteries B1, B2, respectively. In the illustrated example embodiment, battery cavity 120 has a leaf spring contact 124 at one end that is configured to make electrical connection to a battery terminal at one end of battery B1 and has a coil spring contact 126 at its other end that is configured to make electrical connection to a battery terminal at the other end of battery B1.

Leaf spring contact 124 has a part 104 at one end that provides external terminal 104 of battery assembly 100. Leaf spring contact 124 also has a tab or projection 124T for connecting to an opening 142 of circuit board 140 and a location 124B at which the leaf spring contact 124 makes physical and electrical contact with a battery terminal at one end of battery B1.

Wire coil spring contact 126 has a helical coil 126B at one end for connecting to battery B1 and has a wire end 126T that connects to circuit structure 140, e.g., an electrical circuit board 140, which includes electrical conductors to connect contact 126 to external terminal 106 of battery assembly 100. Contact 106 that provides external terminal 106 connects via its tab 106T and circuit board 140 to spring contact 126.

Also in the illustrated example embodiment, battery cavity 130 has a leaf spring contact 134 at one end that is configured to make electrical connection to a battery terminal at one end of battery B2 and has a at its other end a wire spring contact 136 that is configured to make electrical connection to a battery terminal at the other end of a battery B2. Leaf spring contacts 134 have a square part 134B to which a terminal at one end of battery B2 makes contact and have a tab 134T at an end that connects to circuit board 140. Wire coil spring contacts 136 have a helical coil 136B at one end for connecting to a terminal at the other end of a battery B2 and have a wire end 136T that connects to electrical circuit board 140.

Electrical circuit board 140 has plural openings into which the tabs of contacts 124, 126, 134, 136 are disposed to be connected, e.g., soldered, to make electrical contact with the electrical conductors of circuit board 140. The electrical conductors of circuit board 140 are configured to connect battery B1 contacts 124 and 126 to external terminals 104 and 106, respectively, and to connect batteries B2 in series connection with the upper contact 134 connected to external terminal 104 and with the lower contact 136 to external terminal 106, respectively. Thus, separate contacts are provided for battery B1 and for batteries B2.

Battery assembly 100, as well as main housing 110 and housing cover 160, are considered to define a longitudinal direction or axis 101 along its longer dimension as illustrated in, e.g., FIGS. 4A-4B. Each battery cavity or receptacle 120, 130 is disposed transversely to longitudinal direction 101, wherein, e.g., battery receptacle 120 is angled in a first direction relative to longitudinal direction 101 and battery receptacles 130 are angled in a second and different direction relative to longitudinal direction 101.

As used herein “transverse” and transversely” refer to being cross-wise or across a direction or axis, e.g., at an angle in a range from greater than 0° to less than 180° relative to axis 101. The foregoing range of angles includes being angled at an acute angle or perpendicularly relative to axis 101. In the illustrated example embodiment, receptacle 120 is angled transversely at an angle A1 of about 21° with respect to longitudinal direction 101 and receptacles 130 are angled transversely at an angle A2 in the opposite direction of about 44° with respect to longitudinal direction 101.

Because battery receptacles 120, 130 are configured transversely at respective angles, e.g., one clockwise relative to longitudinal direction 101 at an angle A2 and the other counter-clockwise at an angle A1 relative to longitudinal direction 101, they lie relatively diagonally (transversely) in battery assembly 100. As a result, at least two advantages may be realized: cushioning and capacity to carry more or larger batteries.

The advantages of orienting batteries transversely to a longitudinal direction, e.g., transversely to axis 101, are present even in batteries that are disposed in devices that accommodate only a single battery or battery type, such as battery B2, without having any contacts or receptacle for a battery or batteries B1. For example, the housing 110 as illustrated in FIGS. 3A, 3B and 4A, 4B need only have a receptacle 120 for a battery B1 and no receptacles 130 for batteries B2, or need only have receptacles 130 for a batteries B1 and no receptacles 120 for a battery B2.

Battery assembly 100 as well as a light including such battery pack 100, e.g., like an example light 10, are likely to be set down on horizontal surfaces in the orientations illustrated in FIG. 1, e.g., on their respective “bottoms.” In such case, the force of impact with such surface that is transferred to the end of batteries B1 or B2 will be reduced from that experienced if battery B1 or batteries B2 were aligned with the longitudinal direction 101. This is a helpful effect because the seals at the ends of cylindrical and other batteries like batteries B1 and B2 can be relatively more fragile than are the sides of their cases. Similarly, if a battery assembly 100 or a light containing same were to be set down on its side, a similar reduction of impact force will be realized. More so, when a battery assembly 100 or a light containing such battery assembly 100 be dropped, the impact forces will be significantly higher and the cushioning effect produced by Applicant's novel and inventive arrangement will be even more beneficial.

In addition, Applicant's arrangement for batteries B1, B2 in battery assembly 100 can allow more or larger batteries to be disposed in battery assembly 100. This arrangement can advantageously allow a battery assembly 100 that contains larger capacity batteries to be used to replace previous battery packs that have fewer and/or physically smaller batteries. For example, consider FIG. 1 wherein a battery assembly 100 containing a physically larger battery B1 or three AA batteries B2 will fit into the same space in a light 10 as a previous battery pack 16 which can carry only two AA batteries. Both prior art battery pack 16 and the example inventive battery assembly 100 as illustrated are too short to accept two or more AA batteries in line. Absent Applicant's arrangement, a battery pack 16 would have to be significantly longer to receive plural batteries B2 and, because and that longer length would undesirably require light 10 to also be longer.

Battery receptacles 120 and 130 of main housing part 110 are configured to receive at one end respective electrical contacts 124, 134, e.g., flat leaf spring contacts, for making electrical contacts with a first terminal, e.g., a positive terminal, of batteries B1 and B2 and at their other ends respective electrical contacts 126, 136, e.g., wire contacts with a helical spring at one end, for making electrical contacts with a second terminal, e.g., a negative terminal, of batteries B1 and B2. Electrical contacts 124, 126, 134, 136 have respective locations 124B, 126B, 134B, 136B at which the respective terminals of batteries B1, B2 make physical and electrical contact. Electrical contacts 124, 126, 134, 136 have respective locations 124T, 126T, 134T, 136T, e.g., a small tab or projection 124T, 126T, 134T, 136T, which are disposed in respective openings 142 of electrical circuit board 140 to connect to the electrical conductors of circuit board 140, e.g., via solder connections or physical interference within the openings 142.

In the example illustrated, conductors 104 and 106, e.g., flat spring contacts, include locations 104, 106 which serve as the terminals 104, 106 of battery assembly 100 and have, e.g., a tab or projection 104T, 106T for connecting to an opening 142 of circuit board 140. Circuit board 140 is disposed in a receptacle of the surface opposite to that defining battery receptacles 120, 130 and is enclosed by a circuit board cover 150 which is retained on housing part 110 by a plurality of fasteners, e.g., by extensions or “legs” 152 which engage complementary features 118, e.g., recesses 118, on the exterior of housing part 110.

Battery assembly 100 may include or may not include a main housing cover 160 and may or may not include a fastener 112, 162 and 114, 164 to retain housing part 110 and housing cover 160 adjacent each other. Where a main housing cover 160 is provided, as is preferred in certain instances, it may or may not have battery receptacles of complementary shape and size to those of main housing part 110.

Where housing cover 160 has battery receptacles, battery receptacle 166 of main housing cover 160 may be of complementary size and shape to that of battery receptacle 120 of main housing part 110 and is transverse at an angle A1 so that receptacles, 120, 166, e.g., both being in a general shape of part of a cylinder, thereby cooperate to define a generally cylindrical receptacle 120, 166 configuration, i.e. a cavity for receiving and retaining battery B1.

Where housing cover 160 has battery receptacles, battery receptacles 168 of main housing cover 160 may be of complementary size and shape to that of battery receptacles 130 of main housing part 110 and is transverse at an angle A2 so that receptacles, 130, 168, e.g., both being in a general shape of part of a cylinder, thereby cooperate to define a generally cylindrical receptacle 130, 168 configuration, i.e. cavities for receiving and retaining batteries B2.

In one example configuration, receptacles 120 and 130, and receptacles 166 and 168, are approximately of respective semi-cylindrical shapes and sizes, thereby to define substantially cylindrical cavities for receiving batteries B1 and B2.

FIG. 4C includes views of an example battery B in different angular positions, e.g., at different example angles A, and FIG. 4D is a graphical representation of an effective length L_{EF} thereof as a function of the angle A. When battery B is oriented with its axis along axis 101, its effective length L_{EF} is its length L_{B}. As the angle A between the axis of battery B and axis 101 increases, the effective length L_{EF} increase to a maximum effective length L_{EF-M} which is the diagonal corner-to-corner length of battery B. As angle A increases further the effective length of battery B decreases until at angle A=90° the effective length L_{EF} becomes equal to the diameter of battery B.

The effective length L_{EF} is a function of the length LB and diameter D of battery B approximating a sum of L_{B} cosine A and D sine A which is helpful in determining a suitable angle A at which to provide a receptacle for battery B. It is noted that as a practical matter due to the space required for the exterior and interior contacts of battery assembly 100, the interior length available between diagonally opposite interior corners of housing 110 may accommodate a larger battery, e.g., battery B1, even though at the angle A thereof its effective length L_{EF} may be longer than its actual length L_{B}, and so may provide an advantageous orientation thereof. With batteries B disposed at an angle A, the impact force experienced by a battery B disposed at an angle A within battery assembly 100 may be less than if battery B were aligned with axis 101 of battery assembly 100, e.g., the reduction may approximate a cosine function.

Consideration of this angle A and function shown in FIGS. 4C and 4D would be useful for determining a advantageous angle A for orientation of batteries in a battery housing or compartment of a device. Batteries so installed may be of a single type B or plural types B1 and B2; however, for devices that accommodate batteries of different sizes and/or types (“dual fuel” devices), batteries of different sizes and/or types may be installed exclusively (i.e. in configurations including only a battery or batteries B1 or only a battery or batteries B2) or in combination (i.e. in configurations including both a battery or batteries B1 and a battery or batteries B2).

In a typical embodiment, various parts, e.g., housing parts 110, 150, 160, and the like may be a nylon, reinforced nylon, engineered nylon, nylon 6, nylon 66, polyamide, polyamide 66, reinforced polyamide, reinforced polyamide 66, acrylonitrile butadiene styrene (ABS), polycarbonate, polyethylene, polypropylene, polycarbonate, polyester-polycarbonate blend, ABS polycarbonate blend, or other suitable plastic material, or of a cast, molded, forged, or machined metal.

Metal parts, such as electrical contacts and terminals 124, 126, 134, 136, 104, 106, springs and fasteners, may be of any suitable metal, e.g., aluminum, steel, spring steel, metal wires, brass, bronze, phosphor bronze, magnesium, beryllium copper,, and the like.

Where a part is desired to provide heat sinking, e.g., a main housing part 110, 160, such may include a relatively highly thermally conductive material such as aluminum, brass, copper, magnesium, cast metal, and/or a plastic filled with thermally conductive particles, e.g., a thermally conductive reinforced nylon, engineered nylon, acrylonitrile butadiene styrene (ABS), polycarbonate, polyethylene, polypropylene, polycarbonate, polyester-polycarbonate blend, ABS polycarbonate blend, or other suitable thermally conductive plastic material, e.g., a plastic that includes (is filled with) thermally conductive particles, flakes, strands or other thermally conductive material, as well as other materials having suitable strength and thermal conductivity.

In a typical embodiment, an example battery assembly 100 may be about 3.7 inches (about 9.3 cm) in length, about 2 inches (about 5 cm) in width and about 1.1 inches (about 2.9 cm) thick. Battery B1 may be a size 18650 or other lithium-ion battery or a nickel-metal-hydride battery, and batteries B2 may be size AA alkaline, nickel-metal-hydride or lithium ion batteries. A battery assembly 100 may be of larger or smaller size and of a different shape as may be necessary or desirable for use with different electronic devices, lights and/or portable lights.

A battery assembly for a portable device having a first longitudinal axis may comprise: a battery assembly housing configured to receive at least one unit of a first battery type having a second longitudinal axis, wherein an angle A1 defined by the first and second longitudinal axes is greater than 0 degrees and less than 180 degrees. The battery assembly housing may further be configured to receive at least one unit of a second battery type. The first battery type and the second battery type are electrically connected to the portable device through separate contacts of the battery assembly housing. The second battery type has a third longitudinal axis, and an angle A2 defined by the first and third longitudinal axes is greater than 0 degrees and less than 180 degrees. The portable device may comprise a portable light. The battery assembly housing may be configured to receive either (a) one or more units of the first battery type or (b) one or more units of the second battery type. The housing may be configured to receive both (a) one or more units of the first battery type and (b) one or more units of the second battery type. The battery assembly housing may be removable from the portable device. The number of units of the first battery type or of the second battery type may be equal to one.

A battery assembly may comprise: a battery assembly housing having first and second housing parts each having a respective receiving surface that is configured to be placed adjacent to the receiving surface of the other housing part, the receiving surface of the first housing part having at least a first receptacle for receiving a battery of a first size and having two or more second receptacles for receiving two or more batteries of a second size, wherein the size of the battery of the first size is larger than the size of the batteries of the second size and wherein the two or more second receptacles are transverse to the first receptacle; the receiving surface of the second housing part having a first receptacle complementary to the first receptacle of the first housing part and having two or more second receptacles complementary to the two or more second receptacles of the first housing part; first and second battery assembly terminals supported by the battery assembly housing and accessible from exterior to the battery assembly; first and second battery contacts in each of the first and second receptacles configured to make electrical connection to terminals of the respective battery disposed therein; plural electrical conductors disposed within the battery assembly housing configured to electrically connect the first and second battery contacts in circuit with the first and second battery assembly terminals, respectively; and one or more fasteners retain the first and second housing parts with their respective receiving surfaces adjacent each other. Thus the first receptacles of the first and second housing parts are retained adjacent each other and the second receptacles of the first and second housing parts are retained adjacent each other to define respective first and second cavities that are transverse to one another for receiving batteries of the first and second sizes, respectively, but not at the same time. The plural electrical conductors may comprise: a circuit structure supported by the first housing part and having plural electrical conductors that connect to the first and second battery assembly terminals and to the first and second battery contacts disposed in the first and second receptacles of the first housing part and configured to electrically connect the first and second battery contacts to the first and second battery assembly terminals, respectively. The battery assembly for a portable device may further comprise: a cover covering the circuit structure and fastened to the first housing part. The circuit structure may include an electrical circuit board supporting the plurality of contacts and the plural electrical conductors. The plurality of contacts may be formed of an electrically conductive metal part having an end that fits into an opening of the electrical circuit board for making electrical connection to an electrical conductor of the electrical circuit board and having a battery contact. The battery assembly for a portable device wherein: the first and second battery assembly terminals include a leaf spring contact; or the first and second battery contacts include leaf spring contacts or wire spring contacts or both leaf spring contacts and wire spring contacts; or the first and second battery assembly terminals include a leaf spring contact and the first and second battery contacts include leaf spring contacts or wire spring contacts or both leaf spring contacts and wire spring contacts. The battery assembly for a portable device of claim 1 wherein the one or more fasteners include: a part of a hinge and a part of a latch on the first housing part and a complementary part of the hinge and a complementary part of the latch on the second housing part, whereby the first and second housing parts are hinged together and may be latched adjacent one another by the latch. The battery assembly housing may define a longitudinal direction wherein: the first receptacle of the first housing part is disposed at a first angle in a first direction relative to the longitudinal direction, and two or more second receptacles of the first housing part are disposed at a second angle in a second direction relative to the longitudinal direction, whereby the first receptacle and the two or more second receptacles are disposed transversely to each other and relative to the longitudinal direction. The portable device may comprise a portable light.

A battery assembly for a portable device may comprise: a first housing part having at least a first receptacle for receiving a battery of a first size and having two or more second receptacles for receiving two or more batteries of a second size, wherein the size of the battery of the first size is larger than the size of the batteries of the second size and wherein the two or more second receptacles are configured to be transverse to the first receptacle, whereby the first housing part can not receive the battery of the first size and the two or more batteries of the second size at the same time; first and second battery assembly terminals supported by the first housing part and accessible from exterior to the battery assembly to provide an externally accessible battery positive terminal and an externally accessible battery negative terminal; plural electrical conductors disposed with the first housing part and configured to electrically connect terminals of the battery of the first size and terminals of the batteries of the second size in circuit with the first and second battery assembly terminals, respectively. Thus the battery assembly defines respective first and second cavities that are transverse to one another for receiving batteries of the first and second sizes, respectively, but not at the same time. The battery assembly for a portable device may further comprise: a second housing part complementary to the first housing part and configured to be placed adjacent to the first housing part for retaining the battery of the first size when present and for retaining the two or more batteries of the second size when present, in their respective receptacles. The battery assembly for a portable device may further comprise: one or more fasteners configured to retain the first and second housing parts adjacent each other. The first housing part may include a part of a hinge and a part of a latch and the second housing part may include a complementary part of the hinge and a complementary part of the latch, whereby the first and second housing parts are hinged together and may be latched adjacent one another by the latch. The second housing part may: have at least a first receptacle that is complementary to the at least a first receptacle of the first housing part for receiving a battery of the first size, and may have two or more second receptacles that are complementary to the two or more second receptacles of the first housing part for receiving two or more batteries of the second size, wherein the two or more second receptacles of the second housing part are transverse to the at least the first receptacle thereof, whereby the battery assembly can not receive the battery of the first size and the two or more batteries of the second size at the same time. The plural electrical conductors may include: first and second battery contacts in each of the first and second receptacles configured to make electrical connection to terminals of the respective battery disposed therein; or an electrical circuit board supported by the first housing part and supporting ones of the plural electrical conductors; or first and second battery contacts in each of the first and second receptacles configured to make electrical connection to terminals of the respective battery disposed therein and an electrical circuit board supporting the first and second battery contacts and ones of the plural electrical conductors. The battery assembly for a portable device may further comprise: a cover attached to the first housing part to enclose the electrical circuit board. The battery assembly for a portable device may include first and second battery contacts in each of the first and second receptacles configured to make electrical connection to terminals of the respective battery disposed therein, wherein; the first and second battery assembly terminals include a leaf spring contact; or the first and second battery contacts include leaf spring contacts or wire spring contacts or both leaf spring contacts and wire spring contacts; or the first and second battery assembly terminals include a leaf spring contact and the first and second battery contacts include leaf spring contacts or wire spring contacts or both leaf spring contacts and wire spring contacts. The first housing part may define a longitudinal direction and wherein: the first receptacle of the first housing part is disposed at a first angle in a first direction relative to the longitudinal direction, and two or more second receptacles of the first housing part are disposed at a second angle in a second direction relative to the longitudinal direction, whereby the first receptacle and the two or more second receptacles are disposed transversely to each other and relative to the longitudinal direction. The portable device may comprise a portable light.

As used herein, the terms “about,” “approximate” and/or “approximately” mean that dimensions, sizes, formulations, parameters, shapes and other quantities and characteristics are not and need not be exact, but may be approximate and/or larger or smaller, as desired, reflecting tolerances, conversion factors, rounding off, measurement error and the like, judgment, and other factors known to those of ordinary skill in the art. In general, a dimension, size, formulation, parameter, shape or other quantity or characteristic is “about” or “approximate” or “substantial” or “substantially” whether or not expressly stated to be such. It is noted that embodiments of very different sizes, shapes and dimensions may employ the described arrangements.

Although terms such as “front,” “back,” “rear,” “side,” “end,” “top,” “bottom,” “up,” “down,” “left,” “right,” “upward,” “downward,” “forward,” “backward,” “under” and/or “over,” “vertical,” “horizontal,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

As used herein, the term “and/or” encompasses both the conjunctive and the disjunctive cases, so that a phrase in the form “A and/or B” encompasses “A” or “B” or “A and B.” Likewise, a phrase in the form “A, B and/or C” or a phrase in the form “A and/or B and/or C” includes “A,” “B,” “C,” “A and B,” “A and C,” “B and C,” and “A and B and C.” In addition, the term “at least one of” one or more elements is intended to include one of any one of the elements, more than one of any of the elements, and two or more of the elements up to and including all of the elements, and so, e.g., phrases in the form “at least one of A, B and C” include “A,” “B,” “C,” “A and B,” “A and C,” “B and C,” and “A and B and C.”

As used herein, the term “predetermined” means determined in advance or before hand with respect to whatever the term pertains to. The term may be used with respect to a physical object or thing and/or with respect to an intangible thing, e.g., a signal or data, and the like. Examples thereof may include a fixed value, position, condition and/or limit, however, predetermined is not limited to a fixed value, position, condition and/or limit. A predetermined value, position, condition and/or limit may change or otherwise vary over time, over a sequence and/or over a randomized series of values, positions, conditions and/or limits.

As used herein, the term “plurality” means plural, two or greater in number of whatever the term pertains to, i.e. more than one. The term may be used with respect to a physical object or thing and/or with respect to an intangible thing, e.g., a signal or data, and the like. Examples thereof may include a fixed or movable thing, a fixed value, a changeable value, position, condition and/or limit, and the like.

As used herein, the terms “substantial” and “substantially” mean that the thing referred to as being “substantial” or “substantially” is sufficiently similar in form and/or function as to usable in the invention in a manner that is encompassed or suggested by the description and/or claims herein, and/or an equivalent thereof. The terms “substantial” and “substantially” can include and/or can be in addition to the meaning of the terms “about,” “approximate” and/or “approximately” herein.

A “fastener” as used herein may include any fastener or other fastening device that may be suitable for the described use, including threaded fasteners, e.g., bolts, screws and driven fasteners, as well as pins, rivets, nails, spikes, barbed fasteners, clips, clamps, nuts, speed nuts, cap nuts, acorn nuts, and the like. Where it is apparent that a fastener would be removable in the usual use of the example embodiment described herein, then removable fasteners would be preferred in such instances. A fastener may also include, where appropriate, other forms of fastening such as a formed head, e.g., a peened or heat formed head, a weld, e.g., a heat weld or ultrasonic weld, a braze, an adhesive, a clip, a clasp, a latch, and the like.

As used herein, the terms “connected” and “coupled” as well as variations thereof may or may not be intended to be exact synonyms, but may also encompass some similar things and some different things, and those terms are used interchangeably herein. While the term “connected” as indicated by its context may be used generally to refer to elements that have a direct electrical and/or physical contact to each other, whereas the term “coupled” as indicated by its context may be used generally to refer to elements that have an indirect electrical and/or indirect physical contact with each other, e.g., via one or more intermediate elements, so as to cooperate and/or interact with each other, and may include elements in direct contact as well.

The term “battery” may be used herein to refer generally to a source of electrical power as well as to an electro-chemical device comprising one or more electro-chemical cells and/or fuel cells, and so a battery may include a single cell or plural cells, whether as individual units or as a packaged unit. A battery is one example of a type of an electrical power source suitable for a portable or other device. Such devices could employ power sources including, but not limited to, fuel cells, super capacitors, solar cells, and the like, as well as an electro-chemical battery. Any of the foregoing may be intended for a single use or for being rechargeable or for both, and/or plural ones thereof may be combined into a battery pack or battery assembly or other such assembly or pack, and any, some or all thereof may be referred to herein under the general term battery.

Various embodiments of a battery may have one or more battery cells, e.g., one, two, three, four, or five or more battery cells, as may be deemed suitable for any particular device. A battery may employ various types and kinds of battery chemistry types, e.g., a carbon-zinc, alkaline, lead acid, nickel-cadmium (Ni—Cd), nickel-metal-hydride (NiMH) or lithium-ion (Li-Ion) or lithium-ion-phosphate battery type, of a suitable number of cells and cell capacity for providing a desired operating time and/or lifetime for a particular device, and may be intended for a single use or for being rechargeable or for both. Examples may include a three cell lead acid battery typically producing about 6 volts, a four cell NiMH battery typically producing about 4.8 volts, a five cell NiMH battery producing about 6 volts, a Li-Ion battery typically producing about 3.5-3.7 volts, or a two-cell Li-Ion battery typically producing about 7 volts, it being noted that the voltages produced thereby will be higher when approaching full charge and will be lower in discharge, particularly when providing higher current and when reaching a low level of charge, e.g., becoming discharged.

As used herein “transverse” refers to crossing, lying across, being across, in a cross direction, or crosswise, whether perpendicularly or at an acute or obtuse angle, and to directions so arranged or configured. That arrangement can also be said to intersect or pass through or to have an intersection. With regard to things that are three dimensional, transverse can mean that they encompass a common volume where they intersect or that they do not have a volume in common. In the preferred configuration herein, e.g., the first and second receptacles generally do intersect and define a volume in common at their intersection.

As used herein “dual-fuel” refers to lights and electronic devices, e.g., lights, flashlights, lanterns and the like, that can be powered by two or more sources of electrical power, e.g., batteries, of two or more different sizes, types, and/or kinds, at different times and/or at the same time. “Dual-fuel” may also refer to assemblies and/or packages of power sources, battery assemblies and/or battery packs, that can receive or contain two or more sources of electrical power, e.g., batteries, of two or more different sizes, types, and/or kinds, at different times and/or at the same time.

While the present invention has been described in terms of the foregoing example embodiments, variations within the scope and spirit of the present invention as defined by the claims following will be apparent to those skilled in the art. For example, the numbers of batteries B1 and B2 may be different from that of the described example battery assembly 100.

Alternatively or in addition, batteries B1 and/or B2 may be single use batteries, e.g., alkaline batteries, or may be rechargeable batteries of various battery chemistries. While example batteries of generally cylindrical shape are illustrated, the battery assembly described herein can accommodate batteries of other configurations, e.g., square or rectangular batteries, and in such instances the respective receptacles of Applicant's battery assembly are configured to be of shapes and/or sizes as may be suitable for receiving such sizes and shapes of batteries.

While certain features may be described as a raised feature, e.g., a ridge, boss, flange, projection, detent, or other raised feature, such feature may be positively formed or may be what remains after a recessed feature, e.g., a groove, slot, hole, indentation, recess, detent, or other recessed feature, is made. Similarly, while certain features may be described as a recessed feature, e.g., a groove, slot, hole, indentation, recess or other recessed feature, such feature may be positively formed or may be what remains after a raised feature, e.g., a ridge, boss, flange, projection or other raised feature, is made. In addition, where a raised feature engages a recessed feature, such as a cylindrical projection that engages a complementary receptacle, the relative positions of the raised and recessed features may be interchanged or other wise modified.

Each of the U.S. Provisional Applications, U.S. Patent Applications, and/or U.S. Patents, identified herein is hereby incorporated herein by reference in its entirety, for any purpose and for all purposes irrespective of how it may be referred to or described herein.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A battery assembly for a portable device having a first longitudinal axis, comprising:
a battery assembly housing configured to receive at least one unit of a first battery type having a second longitudinal axis, wherein an angle A1 defined by the first and second longitudinal axes is greater than 0 degrees and less than 180 degrees.

2. The battery assembly of claim 1, wherein:
the battery assembly housing is further configured to receive at least one unit of a second battery type.

3. The battery assembly of claim 2, wherein the first battery type and the second battery type are electrically connected to the portable device through separate contacts of the battery assembly housing.

4. The battery assembly of claim 2, wherein the second battery type has a third longitudinal axis, and an angle A2 defined by the first and third longitudinal axes is greater than 0 degrees and less than 180 degrees.

5. The battery assembly of claim 1, wherein the portable device comprises a portable light.

6. The battery assembly of claim 2, wherein the battery assembly housing is configured to receive either (a) one or more units of the first battery type or (b) one or more units of the second battery type.

7. The battery assembly of claim 2, wherein the battery assembly housing is configured to receive both (a) one or more units of the first battery type and (b) one or more units of the second battery type.

8. The battery assembly of claim 1, wherein the battery assembly housing is removable from the portable device.

9. The battery assembly of claim 2, wherein a number of units of the first battery type or of the second battery type is equal to one.

10. A battery assembly for a portable device comprising:
a battery assembly housing having first and second housing parts each having a respective receiving surface that is configured to be placed adjacent to the receiving surface of the other housing part, the receiving surface of the first housing part having at least a first receptacle for receiving a battery of a first size and having two or more second receptacles for receiving two or more batteries of a second size, wherein the size of the battery of the first size is larger than the size of the batteries of the second size and wherein the two or more second receptacles are transverse to the first receptacle, whereby the battery assembly housing can not receive the battery of the first size and the two or more batteries of the second size at the same time;
the receiving surface of the second housing part having a first receptacle complementary to the first receptacle of the first housing part and having two or more second receptacles complementary to the two or more second receptacles of the first housing part;
first and second battery assembly terminals supported by the battery assembly housing and accessible from exterior to the battery assembly;
first and second battery contacts in each of the first and second receptacles configured to make electrical connection to terminals of the respective battery disposed therein;
plural electrical conductors disposed within the battery assembly housing configured to electrically connect the first and second battery contacts in circuit with the first and second battery assembly terminals, respectively; and
one or more fasteners configured to retain the first and second housing parts with their respective receiving surfaces adjacent each other,
whereby the first receptacles of the first and second housing parts are retained adjacent each other and the second receptacles of the first and second housing parts are retained adjacent each other to define respective first and second cavities that are transverse to one another for receiving batteries of the first and second sizes, respectively, but not at the same time.

11. The battery assembly for a portable device of claim 10 wherein the plural electrical conductors comprise:
a circuit structure supported by the first housing part and having plural electrical conductors that connect to the first and second battery assembly terminals and to the first and second battery contacts disposed in the first and second receptacles of the first housing part and configured to electrically connect the first and second battery contacts to the first and second battery assembly terminals, respectively.

12. The battery assembly for a portable device of claim 11 further comprising: a cover covering the circuit structure and fastened to the first housing part.

13. The battery assembly for a portable device of claim 11 wherein the circuit structure includes an electrical circuit board supporting the plurality of contacts and the plural electrical conductors.

14. The battery assembly for a portable device of claim 13 wherein the plurality of contacts are formed of an electrically conductive metal part having an end that fits into an opening of the electrical circuit board for making electrical connection to an electrical conductor of the electrical circuit board and having a battery contact.

15. The battery assembly for a portable device of claim 10 wherein:
the first and second battery assembly terminals include a leaf spring contact; or
the first and second battery contacts include leaf spring contacts or wire spring contacts or both leaf spring contacts and wire spring contacts; or
the first and second battery assembly terminals include a leaf spring contact and the first and second battery contacts include leaf spring contacts or wire spring contacts or both leaf spring contacts and wire spring contacts.

16. The battery assembly for a portable device of claim 10 wherein the one or more fasteners include: a part of a hinge and a part of a latch on the first housing part and a complementary part of the hinge and a complementary part of the latch on the second housing part, whereby the first and second housing parts are hinged together and may be latched adjacent one another by the latch.

17. The battery assembly for a portable device of claim 10 wherein the battery assembly housing defines a longitudinal direction and wherein:
the first receptacle of the first housing part is disposed at a first angle in a first direction relative to the longitudinal direction, and
two or more second receptacles of the first housing part are disposed at a second angle in a second direction relative to the longitudinal direction,
whereby the first receptacle and the two or more second receptacles are disposed transversely to each other and relative to the longitudinal direction.

18. The battery assembly for a portable device of claim 10 wherein the portable device comprises a portable light.

19. A battery assembly for a portable device comprising:
a first housing part having at least a first receptacle for receiving a battery of a first size and having two or more second receptacles for receiving two or more batteries of a second size, wherein the size of the battery of the first size is larger than the size of the batteries of the second size and wherein the two or more second receptacles are configured to be transverse to the first receptacle, whereby the first housing part can not receive the battery of the first size and the two or more batteries of the second size at the same time;
first and second battery assembly terminals supported by the first housing part and accessible from exterior to the battery assembly to provide an externally accessible battery positive terminal and an externally accessible battery negative terminal;
plural electrical conductors disposed with the first housing part and configured to electrically connect terminals of the battery of the first size and terminals of the batteries of the second size in circuit with the first and second battery assembly terminals, respectively; and
whereby the battery assembly defines respective first and second cavities that are transverse to one another for receiving batteries of the first and second sizes, respectively, but not at the same time.

20. The battery assembly for a portable device of claim 19 further comprising:
a second housing part complementary to the first housing part and configured to be placed adjacent to the first housing part for retaining the battery of the first size when present and for retaining the two or more batteries of the second size when present, in their respective receptacles.

21. The battery assembly for a portable device of claim 20 further comprising:
one or more fasteners configured to retain the first and second housing parts adjacent each other.

22. The battery assembly for a portable device of claim 20 wherein the first housing part includes a part of a hinge and a part of a latch and wherein the second housing part includes a complementary part of the hinge and a complementary part of the latch, whereby the first and second housing parts are hinged together and may be latched adjacent one another by the latch.

23. The battery assembly for a portable device of claim 20 wherein the second housing part:
has at least a first receptacle that is complementary to the at least a first receptacle of the first housing part for receiving a battery of the first size, and
has two or more second receptacles that are complementary to the two or more second receptacles of the first housing part for receiving two or more batteries of the second size,
wherein the two or more second receptacles of the second housing part are transverse to the at least the first receptacle thereof, whereby the battery assembly can not receive the battery of the first size and the two or more batteries of the second size at the same time.

24. The battery assembly for a portable device of claim 19 wherein the plural electrical conductors include:
first and second battery contacts in each of the first and second receptacles configured to make electrical connection to terminals of the respective battery disposed therein; or
an electrical circuit board supported by the first housing part and supporting ones of the plural electrical conductors; or
first and second battery contacts in each of the first and second receptacles configured to make electrical connection to terminals of the respective battery disposed therein and an electrical circuit board supporting the first and second battery contacts and ones of the plural electrical conductors.

25. The battery assembly for a portable device of claim 24 further comprising: a cover attached to the first housing part to enclose the electrical circuit board.

26. The battery assembly for a portable device of claim 19 including first and second battery contacts in each of the first and second receptacles configured to make electrical connection to terminals of the respective battery disposed therein, wherein;
the first and second battery assembly terminals include a leaf spring contact; or
the first and second battery contacts include leaf spring contacts or wire spring contacts or both leaf spring contacts and wire spring contacts; or
the first and second battery assembly terminals include a leaf spring contact and the first and second battery contacts include leaf spring contacts or wire spring contacts or both leaf spring contacts and wire spring contacts.

27. The battery assembly for a portable device of claim 19 wherein the first housing part defines a longitudinal direction and wherein:
the first receptacle of the first housing part is disposed at a first angle in a first direction relative to the longitudinal direction, and
two or more second receptacles of the first housing part are disposed at a second angle in a second direction relative to the longitudinal direction,
whereby the first receptacle and the two or more second receptacles are disposed transversely to each other and relative to the longitudinal direction.

28. The battery assembly for a portable device of claim 19 wherein the portable device comprises a portable light.
